(19) United States
(12) Patent Application Publication
(10) Pub. No.: US 2026/0118233 A1
(43) Pub. Date: Apr. 30, 2026

(54) OPTICAL FAULT ISOLATION APPARATUS FOR SEMICONDUCTOR DEVICE AND SEMICONDUCTOR DEVICE SUPPORT PLATE

(71) Applicant: Samsung Electronics Co., Ltd., Suwon-si (KR)

(72) Inventors: Wook-Jin Lee, Suwon-si (KR); Keon-Il Kim, Suwon-si (KR); Dai-Yun Kim, Suwon-si (KR); Ghil-Geun Oh, Suwon-si (KR)

(73) Assignee: Samsung Electronics Co., Ltd., Suwon-si (KR)

(21) Appl. No.: 19/323,699

(22) Filed: Sep. 9, 2025

(30) Foreign Application Priority Data
Oct. 31, 2024 (KR) 10-2024-0152859

(51) Int. Cl. G01N 1/36; G01J 5/00; G01J 5/061; G01N 21/66; G01N 21/95

(52) U.S. Cl. CPC G01N 1/36; G01J 5/0007; G01J 5/061; G01N 21/66; G01N 21/9501; G01N 2201/0231

(57) ABSTRACT

An optical fault detection apparatus includes an optical device configured to detect a defect in a device under test and a plate including a support unit configured to fix the device under test to the plate. The plate includes an opening at its center and a magnetic body disposed along an outer edge of the opening. The support unit includes a first sub-support unit and a second sub-support unit. The first sub-support unit and the second sub-support unit are spaced apart from each other in a first direction. The first sub-support unit and the second sub-support unit are attached to the magnetic body. The device under test includes a first surface attached to the support unit and a second surface opposite the first surface. The first surface is exposed to the optical device through the opening.

### CROSS-REFERENCE TO RELATED APPLICATION

This application claims priority from Korean Patent Application No. 10-2024-0152859 filed on Oct. 31, 2024 in the Korean Intellectual Property Office, and all the benefits accruing therefrom under 35 U.S.C. 119, the contents of which are incorporated by reference in its entirety as if fully set forth herein.

### TECHNICAL FIELD

The present disclosure relates to an optical fault isolation (OFI) apparatus for a semiconductor device and a semiconductor device support plate.

### BACKGROUND

As the size of unit logic in semiconductor devices decreases, there are limitations in physically visualizing actual defects. Optical fault isolation (OFI) analysis technology, which employs various optical techniques to identify the causes of device defects, may be used as one of the electrical fault analysis methods. Conventional OFI analysis technology can only be performed at room temperature, making it difficult to use for defect analysis in automotive electronic products, where high-temperature quality assurance is tested. Accordingly, there is a need for a new OFI system that can detect defects in high or low temperature ranges to improve product yield.

### SUMMARY

An objective of the present disclosure is to provide an optical fault isolation (OFI) apparatus for a semiconductor device with improved defect detection capability.

Another objective of the present disclosure is to provide a semiconductor device support plate with excellent versatility.

The objectives of the present disclosure are not limited to those mentioned above, and other objectives not explicitly stated may be understood by those skilled in the art based on the following description.

According to an aspect of the present disclosure, there is provided an optical fault detection apparatus comprising an optical device configured to detect a defect in a device under test; and a plate including a support unit configured to fix the device under test to the plate, wherein the plate includes an opening at its center and a magnetic body disposed along an outer edge of the opening, the support unit includes a first sub-support unit and a second sub-support unit, the first sub-support unit and the second sub-support unit are spaced apart from each other in a first direction and attached to the magnetic body, the device under test includes a first surface attached to the support unit, and a second surface opposite the first surface, and the first surface is exposed to the optical device through the opening.

According to some embodiments, a semiconductor device support plate comprises a plate including a support unit configured to fix a semiconductor device to the plate; and a temperature control device configured to control a temperature of the support unit, wherein the plate includes an opening at its center and a magnetic body disposed along an outer edge of the opening, the support unit includes a first sub-support unit and a second sub-support unit, the first sub-support unit and the second sub-support unit are spaced apart from each other in the first direction and attached to the magnetic body, the semiconductor device includes a first surface in contact with the support unit, and a second surface opposite the first surface, and the first surface is exposed through the opening.

According to some embodiments, an optical fault detection apparatus comprises an optical device configured to detect a defect in a device under test; a support unit configured to fix the device under test to the support unit; a substrate plate to which the support unit is attached, the substrate plate including an optical window configured to expose the device under test; a temperature control device configured to control the temperature of the support unit and to monitor the temperatures of the support unit and the device under test; and a probe configured to transmit a test signal to the device under test for detecting a defect, wherein the support unit includes a first sub-support unit and a second sub-support unit, the first sub-support unit includes a first heating element configured to conduct heat to the device under test, the second sub-support unit includes a second heating element configured to conduct heat to the device under test, and the temperature control device independently controls temperatures of the first heating element and the second heating element.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a perspective view illustrating a semiconductor device support plate, according to some embodiments.

FIG. 2 is a perspective view illustrating part of the semiconductor device support plate of FIG. 1.

FIG. 3 is an enlarged perspective view illustrating region A of FIG. 1.

FIG. 4 is an enlarged top view illustrating region A of FIG. 1.

FIGS. 5 and 6 are perspective views illustrating an optical fault isolation (OFI) apparatus, according to some embodiments.

FIGS. 7 through 10 are perspective views illustrating methods for detecting an optical fault in a device under test using the OFI apparatus and the semiconductor device support plate, according to some embodiments.

FIG. 11 is a cross-sectional view illustrating a device under test, according to some embodiments.

FIG. 12 is a graph for explaining the effects of the semiconductor device support plate, according to some embodiments.

FIG. 13 is a diagram for explaining the effects of the semiconductor device support plate, according to some embodiments.

FIG. 14 is a diagram for explaining the effects of the semiconductor device support plate, according to some embodiments.

FIGS. 15 and 16 are perspective views illustrating a semiconductor device support plate, according to some embodiments.

FIGS. 17 and 18 are perspective views illustrating how to use semiconductor device support plates in OFI an apparatus, according to some embodiments.

### DETAILED DESCRIPTION

Embodiments of the present disclosure will hereinafter be described in detail with reference to the accompanying drawings. The same reference numerals are used for the same components in the drawings, and redundant descriptions thereof will be omitted.

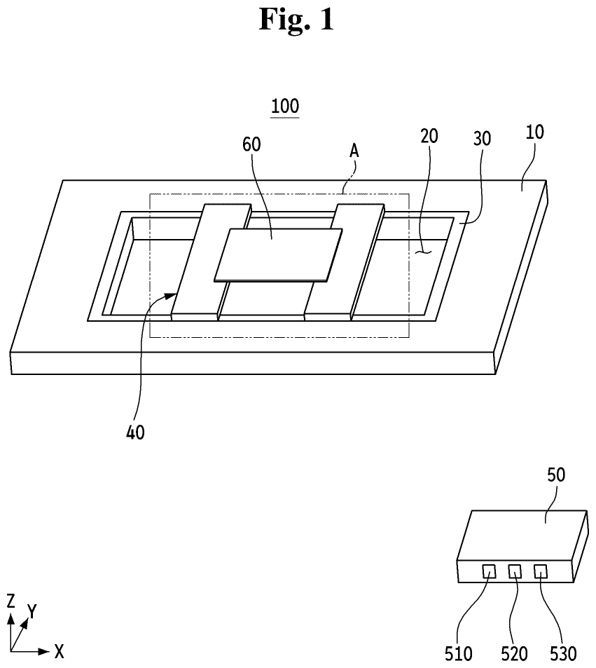

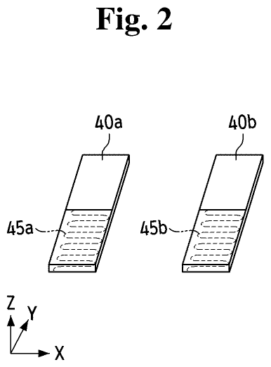

FIG. 1 is a perspective view illustrating a semiconductor device support plate according to some embodiments. FIG. 2 is a perspective view illustrating part of the semiconductor device support plate of FIG. 1.

Referring to FIGS. 1 and 2, a semiconductor device support plate 100 may include a plate 10 and a temperature control device 50.

The plate 10 may include an opening 20, a magnetic body 30, and a support unit 40.

The opening 20 may be formed at a center of the plate 10. In some embodiments, the opening 20 may be rectangular in shape, extending in a first direction (e.g., an X direction) and a second direction perpendicular to the first direction (e.g., a Y direction). A height of the opening 20 in a vertical direction may be the same as the height of the plate 10.

The magnetic body 30 may be formed along the outer edges of the opening 20. The magnetic body 30 may include a magnetic material.

The support unit 40 and the magnetic body 30 may be fixed using the magnetism of the magnetic body 30. The support unit 40 may include a first sub-support unit 40a and a second sub-support unit 40b. According to some embodiments, the support unit 40 may have a bar shape extending in the second direction (e.g., the Y direction).

In some embodiments, the first sub-support unit 40a and the second sub-support unit 40b may be spaced apart from each other along the first direction and attached to the magnetic body 30. The position where the support unit 40 is attached to the magnetic body 30 may be adjusted according to the size of a device 60 under test. By changing the position of the support unit 40, a semiconductor device support plate with excellent versatility can be provided, allowing for the attachment of devices 60 under test of various shapes and sizes.

In some embodiments, the support unit 40 may include heating elements 45a and 45b. For example, the first sub-support unit 40a may include a first heating element 45a and the second sub-support unit 40b may include a second heating element 45b.

The support unit 40 may include a metallic material capable of being attached to the magnetic body 30 and conducting heat generated by the first heating element 45a and the second heating element 45b. For example, the first sub-support unit 40a and the second sub-support unit 40b may each include stainless steel.

In some embodiments, the support unit 40 may fix the device 60 under test to the support unit 40. For example, the device 60 under test may be attached to the support unit 40 using heat-resistant tape.

In some embodiments, the device 60 under test may include a wafer, a semiconductor chip, or a semiconductor package. For example, the device 60 under test may be a semiconductor chip, but the present disclosure is not limited thereto.

The temperature control device 50 may include a temperature controller 510, a first monitor 520, and a second monitor 530.

In some embodiments, the temperature of the support unit 40 may be individually controlled by the temperature controller 510. Specifically, the temperature controller 510 may individually control the temperatures of the first heating element 45a and the second heating element 45b. For example, the temperature controller 510 may individually set the temperatures of the first heating element 45a and the second heating element 45b to a range between room temperature and 250 degrees Celsius.

As heat is generated by the support unit 40, the heat may be conducted to the device 60 under test that is in contact with the support unit 40, and as a result, the temperature of the device 60 under test may increase. The effects of controlling the temperature of the device 60 under test will be described elsewhere in this disclosure.

In some embodiments, the first monitor 520 may monitor the temperatures of the first heating element 45a and the second heating element 45b. The second monitor 530 may monitor the temperature of the device 60 under test.

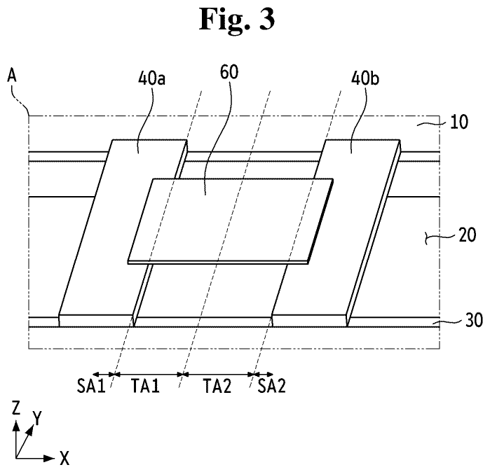

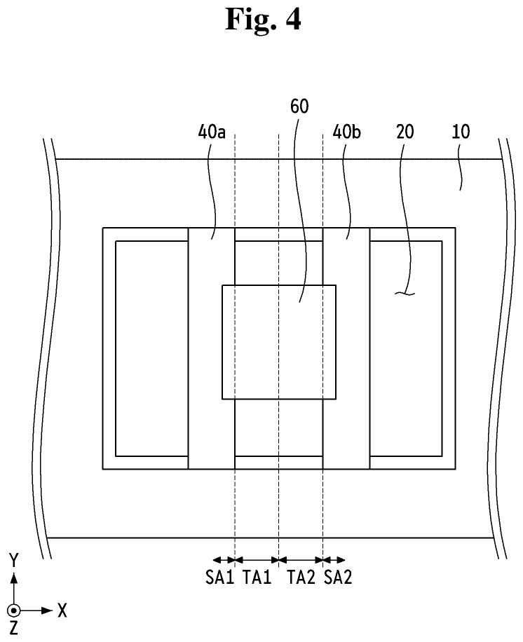

FIG. 3 is an enlarged perspective view illustrating region A of FIG. 1. FIG. 4 is an enlarged top view illustrating region A of FIG. 1.

Referring to FIGS. 3 and 4, the device 60 under test may be fixed to the support unit 40. Specifically, the device 60 under test may include a first edge area SA1, a second edge area SA2, a first test area TA1, and a second test area TA2.

The first edge area SA1 may overlap with the first sub-support unit 40a in the first direction. The second edge area SA2 may overlap with the second sub-support unit 40b in the first direction. The first test area TA1 may not overlap with the first sub-support unit 40a in the first direction and may be adjacent to the first edge area SA1. The second test area TA2 may not overlap with the second sub-support unit 40b in the first direction and may be adjacent to the second edge area SA2.

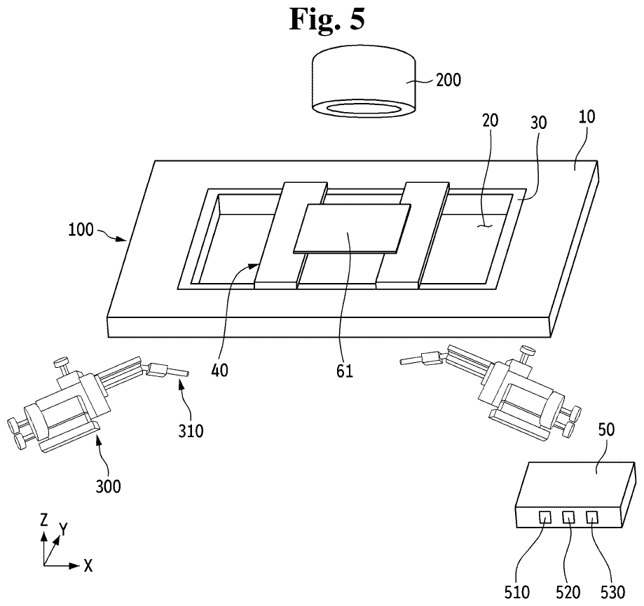

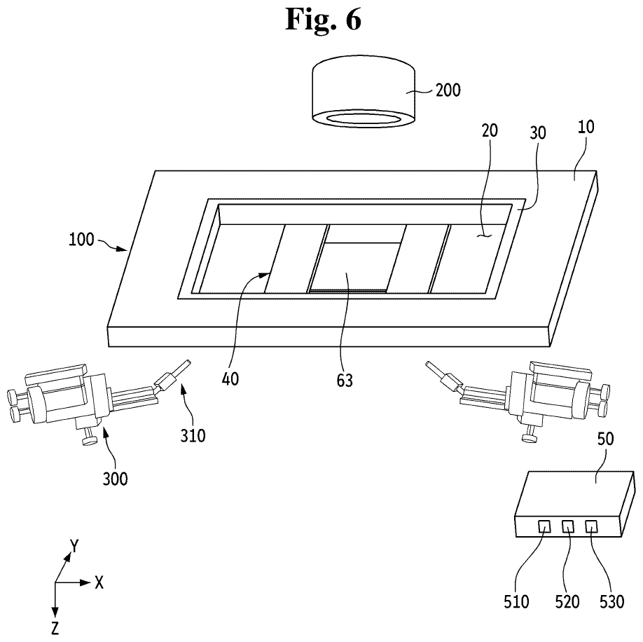

That is, by attaching only portions of the device 60 under test (e.g., the first edge area SA1 and the second edge area SA2) to the support unit 40, both an upper surface (61 in FIG. 5) and a lower surface (63 in FIG. 6) of the device 60 under test may be exposed. Specifically, the lower surface 63 of the device 60 under test may be exposed through the opening 20. The effects of exposing both the upper surface 61 and the lower surface 63 of the device 60 under test will be described elsewhere in this disclosure.

In some embodiments, the temperatures of the first edge area SA1 and the first test area TA1 of the device 60 under test, adjacent to the first sub-support unit 40a, and the temperatures of the second edge area SA2 and the second test area TA2 of the device 60 under test, adjacent to the second sub-support unit 40b, may be different. Specifically, the temperature controller 510 may maintain the first sub-support unit 40a at a high temperature (e.g., 250 degrees Celsius) and the second sub-support unit 40b at a low temperature (e.g., room temperature). In this case, the temperatures of the first edge area SA1 and the first test area TA1 adjacent to the first sub-support unit 40a may be higher than the temperatures of the second edge area SA2 and the second test area TA2 adjacent to the second sub-support unit 40b.

That is, the semiconductor device support plate 100 can control the temperature of the device 60 under test differently from region to region. Accordingly, the stability of testing can be ensured by considering the characteristics of the device 60 under test (e.g., heat resistance).

FIGS. 5 and 6 are perspective views illustrating an optical fault isolation (OFI) apparatus according to some embodiments. For convenience of explanation, only part of the OFI apparatus is illustrated, but the present disclosure is not limited thereto and may include other configurations.

Referring to FIG. 5, the OFI apparatus may perform OFI analysis. The OFI analysis may include photon emission microscopy (PEM), which detects abnormal floating or leakage current caused by physical defects using an optical technique, and thermal emission analysis, which detects heat generated by resistance due to abnormal current paths caused by physical defects.

The OFI apparatus may include an optical device 200, a semiconductor device support plate 100, and a probe 300.

In some embodiments, the optical device 200 may track the position where heat or photons are emitted, thereby locating a defect. For example, the optical device 200 may include a photon emission microscope or an infrared camera.

In some embodiments, the probe 300 may probe an external connection terminal (not illustrated) of the device 60 under test. Specifically, the probe 300 may contact the device 60 under test with a needle 310 to provide a test signal, inducing the generation of heat or photons at the location of a defect. For example, the external connection terminal may be formed of a conductive material shaped as a ball or pin.

The semiconductor device support plate 100 may be identical to the semiconductor device support plate 100 described with reference to FIGS. 1 through 4, and a detailed description thereof will be omitted.

In some embodiments, the semiconductor device support plate 100 may be arranged such that an upper surface 61 of the device 60 under test may face the optical device 200. The optical device 200 may detect a defect in the device 60 under test by examining the upper surface 61 of the device 60 under test.

Referring to FIG. 6, the semiconductor device support plate 100 may be rotated 180 degrees about an axis in the second direction (e.g., the Y direction). That is, the semiconductor device support plate 100 may be arranged such that the lower surface 63 of the device 60 under test may face the optical device 200. As the lower surface 63 of the device 60 under test is exposed, the optical device 200 may detect a defect in the device 60 under test by examining the lower surface 63 of the device 60 under test.

The operation of the OFI apparatus will be described elsewhere in this disclosure.

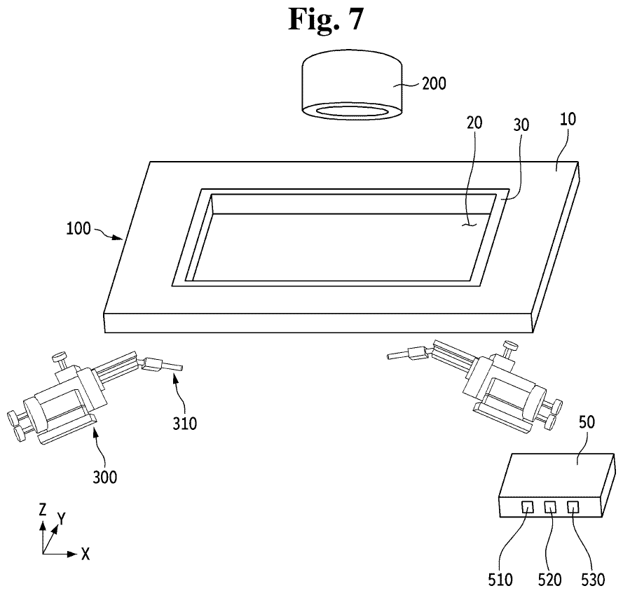

FIGS. 7 through 10 are perspective views illustrating methods for detecting an optical fault in a device under test using the OFI apparatus and the semiconductor device support plate according to some embodiments. For convenience of explanation, only part of the OFI apparatus is illustrated in FIGS. 7 through 10.

Referring to FIG. 7, the semiconductor device support plate 100 may be disposed to support the device 60 under test below the optical device 200. The semiconductor device support plate 100 may include the plate 10 and the temperature control device 50.

The plate 10 may include the opening 20 and the magnetic body 30. The opening 20 may be formed at the center of the plate 10, and the magnetic body 30 may be formed along the outer edges of the opening 20.

As described elsewhere in this disclosure, as the plate 10 includes the opening 20, the semiconductor device support plate 100 can support the device 60 under test while exposing both the upper surface 61 and lower surface 63 of the device 60 under test.

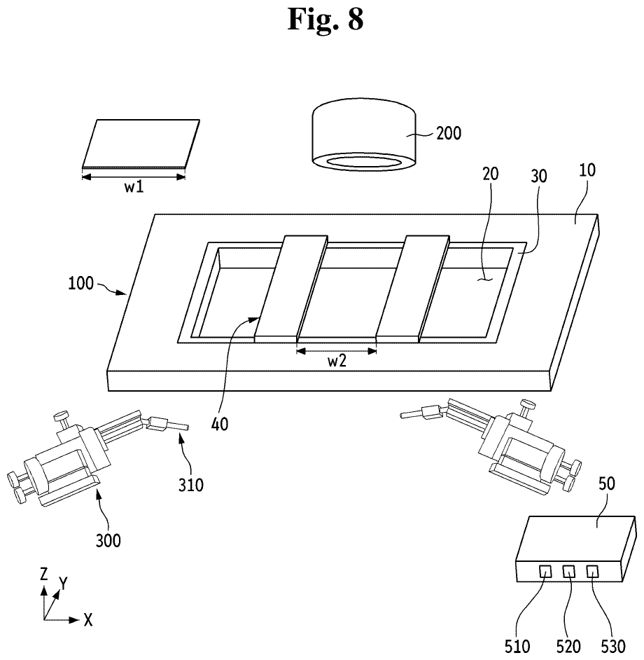

Referring to FIG. 8, the support unit 40 may be attached to the magnetic body 30. The support unit 40 may include the first sub-support unit 40a and the second sub-support unit 40b. The first sub-support unit 40a and the second sub-support unit 40b may be spaced apart from each other in the first direction according to the size of the device 60 under test. For example, if the width of the device 60 under test is width w1, a spacing between the first sub-support unit 40a and the second sub-support unit 40b in the first direction may be spacing w2. The support unit 40 may be attached to the magnetic body 30 such that the spacing w2 may be smaller than the width w1.

By changing the positions of the first sub-support unit 40a and the second sub-support unit 40b, a semiconductor device support plate 100 with versatility can be provided, enabling the attachment of devices 60 under test of various shapes and sizes.

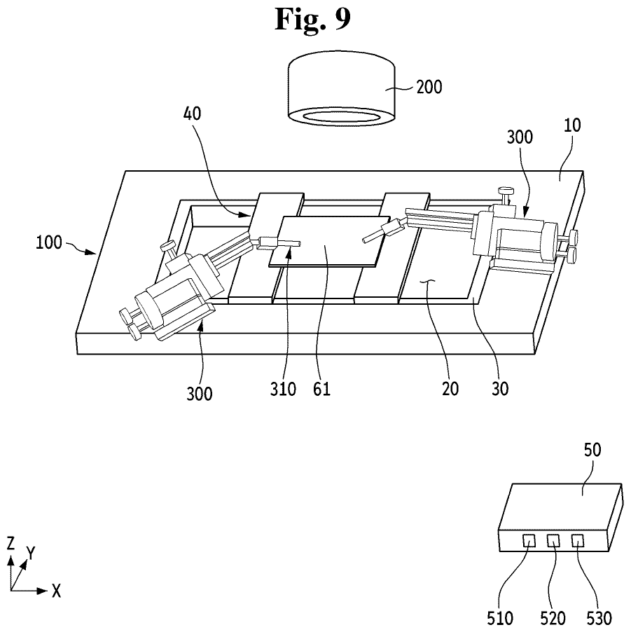

Referring to FIG. 9, the device 60 under test may be fixed onto the support unit 40.

In some embodiments, the first sub-support unit 40a and the second sub-support unit 40b may have their temperatures controlled by the temperature control device 50. The device 60 under test may attain a high temperature due to heat conducted from the first sub-support unit 40a and the second sub-support unit 40b. Through this, the capability of detecting defects in the device 60 under test may be enhanced.

The semiconductor device support plate 100 may be arranged such that the upper surface 61 of the device 60 under test may face the optical device 200. Although not illustrated, an external connection terminal may be disposed on the upper surface 61 of the device 60 under test.

In some embodiments, the probe 300 may probe the external connection terminal (not illustrated) of the device 60 under test. Specifically, the probe 300 may contact the device 60 under test with a needle 310 to provide a test signal, inducing the generation of heat or photons at the location of a defect. For example, the external connection terminal may be formed of a conductive material shaped as a ball or pin.

In some embodiments, the optical device 200 may track the position where heat is generated, thereby locating a defect.

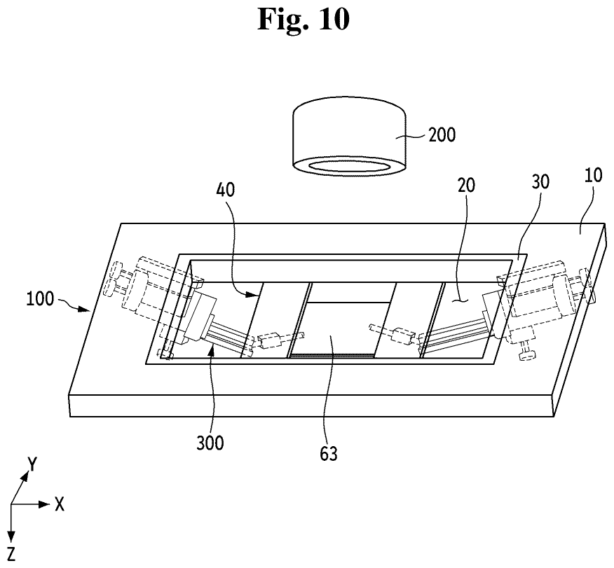

Referring to FIG. 10, the semiconductor device support plate 100 may be rotated 180 degrees about an axis in the second direction (e.g., the Y direction). That is, the semiconductor device support plate 100 may be arranged such that the lower surface 63 of the device 60 under test may face the optical device 200.

As the first sub-support unit 40a and the second sub-support unit 40b are spaced apart from each other in the first direction within the opening 20 of the semiconductor device support plate 100 to supports the device 60 under test, and the device 60 under test is fixed onto the support unit 40, both the upper surface 61 and the lower surface 63 of the device 60 under test may be exposed to the optical device 200. By exposing both the upper surface 61 and lower surface 63 of the device 60 under test, the optical device 200 can perform defect detection on all surfaces of the device 60 under test. Specifically, defect detection may be performed on only the upper surface 61, only the lower surface 63, or both the upper surface 61 and the lower surface 63 sequentially. Therefore, different defect detection methods can be selected for the device 60 under test.

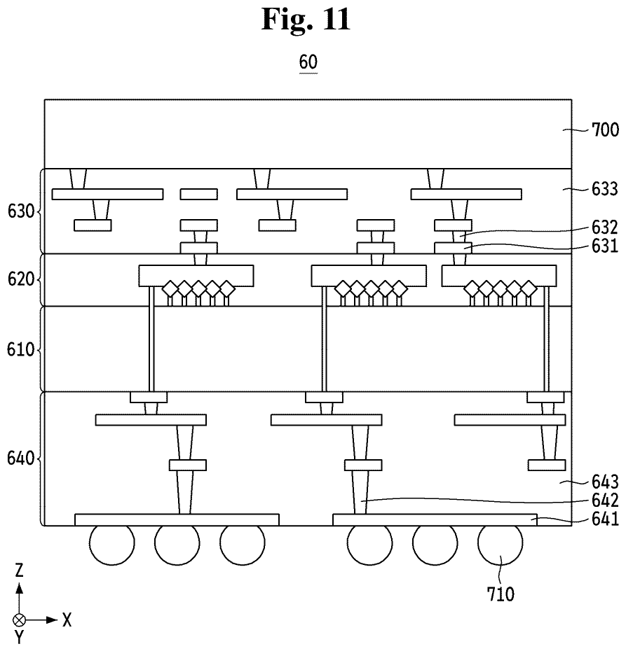

FIG. 11 is a cross-sectional view illustrating a device 60 under test, according to some embodiments.

Referring to FIG. 11, the device 60 under test may be a semiconductor chip having a back-side power distribution network (BSPDN).

In some embodiments, a first substrate 610 may be doped with a p-type or n-type dopant. In other embodiments, the first substrate 610 may not be doped. In one embodiment, the first substrate 610 may include bulk silicon, silicon (Si)-on-insulator (SOI), Si, silicon-germanium (SiGe), SiGe-on-insulator (SGOI), silicon carbide, indium antimonide, a lead telluride compound, indium arsenide, indium phosphide, gallium arsenide, or gallium antimonide, but is not limited thereto.

A front-end-of-line (FEOL) structure 620 may be formed on the first substrate 610.

A first back-end-of-line (BEOL) structure 630 may be formed on the FEOL structure 620. The first BEOL structure 630 may include a first metal wiring structure and a first inter-metal dielectric (IMD) 633 that insulates the first metal wiring structure. The first metal wiring structure may include first metal wiring layers 631 and a first contact plugs 632. The first IMD 633 may embed and insulate the first metal wiring layers 631 and the first contact plugs 632.

A second substrate 700 may be bonded to the first BEOL structure 630.

In some embodiments, a second wiring structure 640 may be disposed on the back side of the first substrate 610 opposite the FEOL structure 620. The second wiring structure 640 may serve as a back-side power distribution network (BSPDN). The BSPDN may supply power to the FEOL structure 620.

The second wiring structure 640 may include a second metal wiring structure and a second IMD 643. The second wiring structure 640 may supply power to respective elements.

The second metal wiring structure may include second metal wiring layers 641 and second contact plugs 642.

As described above, in a case where the device 60 under test is a semiconductor chip having a BSPDN, the device 60 under test may include metal wiring structures on both its upper surface 61 and lower surface 63. Accordingly, there may be restrictions when observing both the upper surface 61 and the lower surface 63 of the device 60 under test. However, when detecting a defect in a semiconductor chip with a BSPDN using the semiconductor device support plate 100 of the present disclosure, defect detection performance can be improved.

The device 60 under test is not limited to a semiconductor chip with a BSPDN. For example, the device 60 under test may be a wafer, a semiconductor chip, or a semiconductor package having a front-side power distribution network (FSPDN).

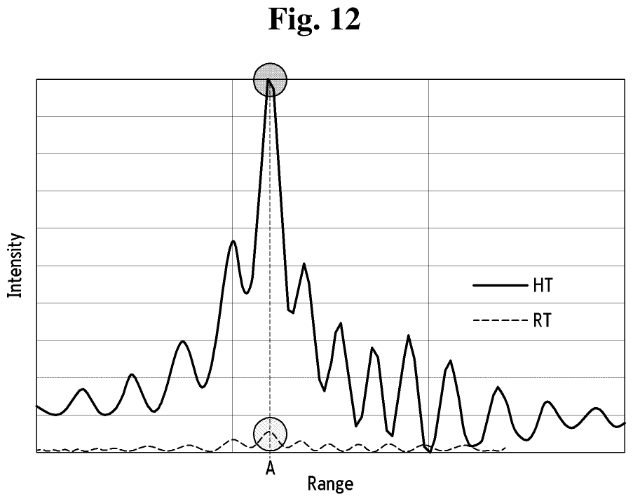

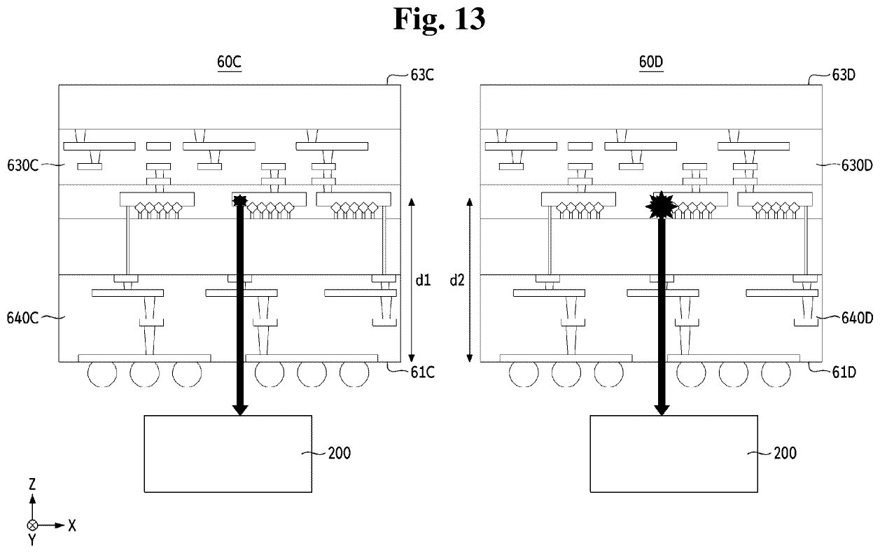

FIG. 12 is a graph for explaining the effects of the semiconductor device support plate according to some embodiments. FIG. 13 is a diagram for explaining the effects of the semiconductor device support plate, according to some embodiments. FIG. 13 describes the device 60 under test as a semiconductor chip with a BSPDN, but the device 60 under test is not limited to a semiconductor chip with a BSPDN.

Referring to the graph of FIG. 12, the x-axis indicates the position of a defect in the device 60 under test, and the y-axis indicates the intensity of a detection signal. A solid line HT of the graph represents the intensity of the detection signal at high temperature, while a dotted line RT represents the intensity of the detection signal at room temperature.

According to the Stefan-Boltzmann law, the intensity of thermal radiation energy is proportional to the fourth power of the absolute temperature, as indicated by Equation (1):

$$\frac{P}{A} = σ ε {T}^{4} ( σ = 5.6703 \times 1 {0}^{- 8} W {m}^{- 2} {K}^{- 4} ) \qquad Equation ( 1 )$$

where σ represents the Stefan-Boltzmann constant, ε represents the emissivity, and T represents the absolute temperature. Accordingly, as the temperature increases, the thermal emission intensity of a radiating body can increase, as indicated by Equation (1).

In some embodiments, the difference in the intensity of the detection signal at point A of the device 60 under test between room temperature and high temperature is the greatest. For example, at point A, the intensity of the detection signal at high temperature may be at least three times greater than at room temperature. That is, the higher the temperature of the device 60 under test, the greater the intensity of the detection signal for detecting a defect in the device 60 under test.

In other words, when the device 60 under test is tested at high temperature using the temperature control device 50, the detection capability may be improved than when tested at low temperature.

Referring to FIG. 13, a first device 60C under test and a second device 60D under test correspond to the same device under test. The first device 60C under test shows the intensity of the detection signal at room temperature (as indicated by the small “starburst”), and the second device 60D under test shows the intensity of the detection signal at high temperature (as indicated by the large “starburst”). As illustrated in FIG. 12, when a defect occurring at the same depth and location is measured, the intensity of the detection signal measured for the second device 60D under test is greater.

That is, by including the semiconductor device support plate 100, which can increase the temperature of the device 60 under test, an OFI apparatus with improved performance can be provided.

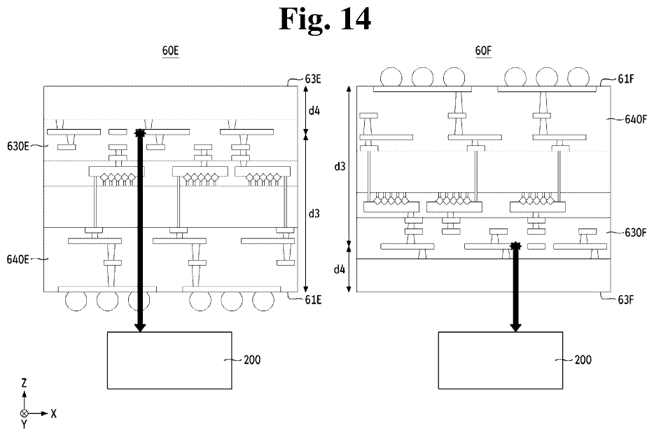

FIG. 14 is a diagram for explaining the effects of the semiconductor device support plate according to some embodiments. FIG. 14 describes the device 60 under test as a semiconductor chip having a BSPDN, but the device 60 under test is not limited thereto.

Referring to FIG. 14, a third device 60E under test and a fourth device 60F under test correspond to the same device under test. In some embodiments, the third device 60E and the fourth device 60F under test may correspond to semiconductor chips having a BSPDN.

In the third device 60E under test, the defect occurs at a location that is a distance d3 away from the upper surface 61E and a distance d4 away from the lower surface 63E. In the fourth device 60F under test, which is the same as the third device 60E under test, the defect occurs at a location that is the distance d3 away from the upper surface 61F and the distance d4 away from the lower surface 63F.

In the case of the third device 60E under test, the detection signal was measured while the upper surface 61E of the third device 60E under test faced the optical device 200. Conversely, for the fourth device 60F under test, the detection signal was measured while the lower surface 63F of the fourth device 60F under test faced the optical device 200.

The intensity of the signal detected by the optical device 200 may be greater for the fourth device 60F under test, where the location of the defect is closer to the optical device 200.

That is, since the upper surface 61 and the lower surface 63 of the device 60 under test are both exposed, and the semiconductor device support plate 100 can be rotated, the optical device 200 can perform defect detection on all surfaces of the device 60 under test. Specifically, defect detection may be performed only on the upper surface 61, only on the lower surface 63, or sequentially on both the upper surface 61 and the lower surface 63. Therefore, different defect detection methods can be selected for the device 60 under test. Accordingly, an OFI apparatus with improved performance can be provided regardless of the location of the defect.

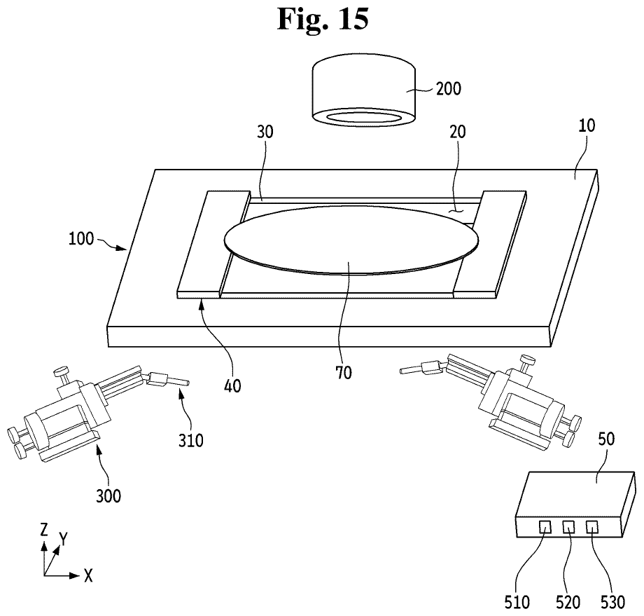

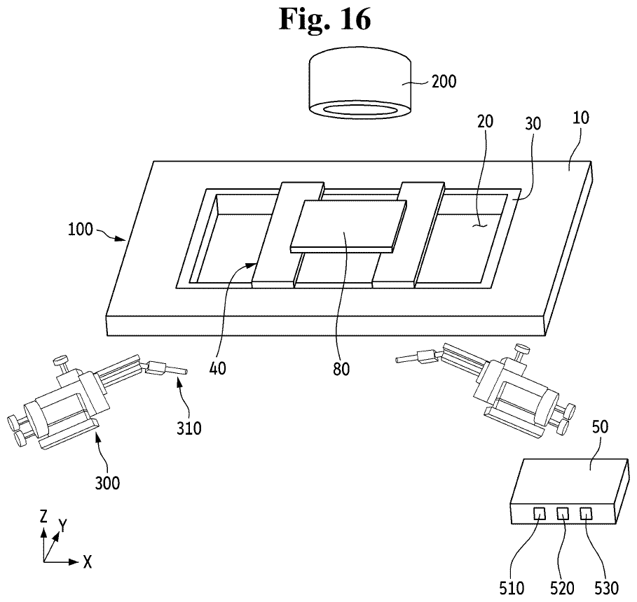

FIGS. 15 and 16 are perspective views illustrating a semiconductor device support plate, according to some embodiments.

FIGS. 15 and 16 correspond to FIG. 1, and thus, any redundant descriptions will be omitted.

Referring to FIG. 15, the semiconductor device support plate 100 in an OFI apparatus may support a wafer 70.

Referring to FIG. 16, the semiconductor device support plate 100 in OFI apparatus may support a semiconductor package 80.

That is, as described above, the semiconductor device support plate 100 may be a versatile semiconductor device support plate capable of attaching devices under test of various shapes and sizes.

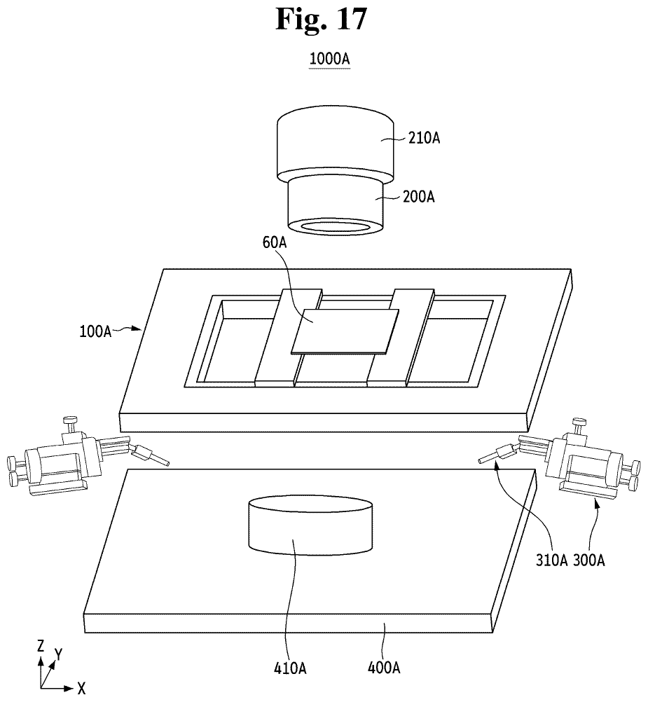

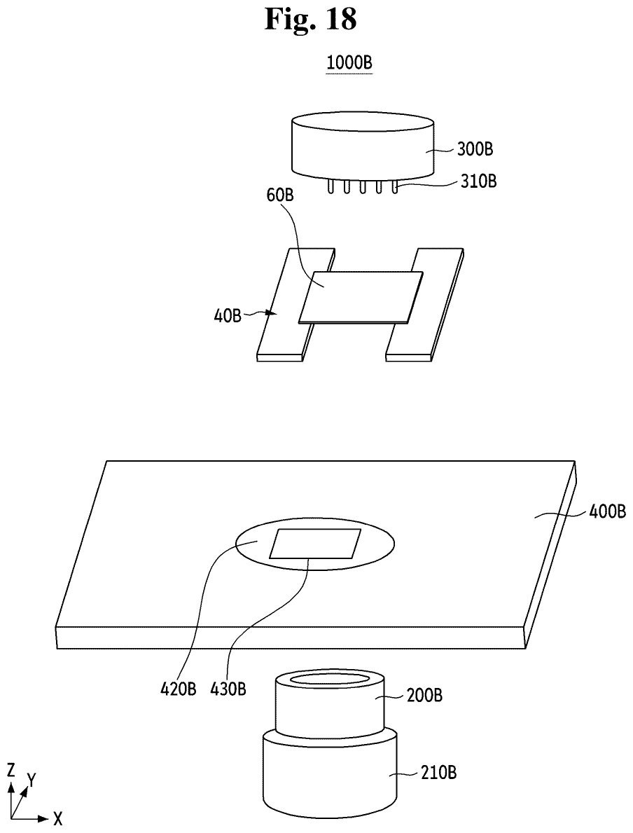

FIGS. 17 and 18 are perspective views illustrating how to use semiconductor device support plates in OFI apparatuses, according to some embodiments. For convenience of explanation, only parts of the OFI apparatuses are illustrated in FIGS. 17 and 18, but the present disclosure is not limited thereto and may include other configurations.

Referring to FIG. 17, an optical fault isolation apparatus 1000A may include an optical device 200A, a probe 300A, and a body 400A including an electrostatic chuck 410A. The optical device 200A may be attached to a head unit 210A, and may thus be movable in a first direction (e.g., an X direction) or a second direction (e.g., a Y direction).

A device 60A under test for OFI may be arranged on the electrostatic chuck 410A.

The probe 300A may contact the device 60A under test using a needle 310A to provide a test signal. The optical device 200A may measure a signal detected in the device 60A under test and perform OFI on the device 60A under test.

If the device 60A under test is placed on the electrostatic chuck 410A, testing cannot be performed on both the upper and lower surfaces of the device 60A under test.

However, when the semiconductor device support plate is placed between the optical device 200A and the electrostatic chuck 410A, the support plate 100A may be rotated to allow testing on both the upper surface and lower surface of the device 60A under test. Additionally, the device 60A under test can be tested in a high-temperature environment, enhancing the detection capability of the detected signal.

As such, the semiconductor device support plate 100A may be used in existing devices. FIG. 17 illustrates the use of the semiconductor device support plate 100A in the OFI apparatus 1000A, but the present disclosure is not limited thereto. The semiconductor device support plate 100A may be used in any equipment requiring a high-temperature environment.

Referring to FIG. 18, an optical fault isolation apparatus 1000B may include an optical device 200B, a probe 300B, and a body 400B including a substrate plate 420B. The optical device 200B may be attached to a head unit 210B, and may thus be movable in a first direction (e.g., an X direction) or a second direction (e.g., a Y direction).

A device 60B under test for OFI may be arranged on the substrate plate 420B.

The probe 300B may contact the device 60B under test using a needle 310B to provide a test signal. The optical device 200B may measure a signal detected in the device 60B under test and perform OFI on the device 60B under test.

When the device 60B under test is placed on the substrate plate 420B, testing can be performed only on surfaces exposed through an optical window 430B of the substrate plate 420B.

However, when a support unit 40B is placed on the body 400B, and the device 60B under test is attached to the support unit 40B, the support unit 40B may be rotated to allow testing on both the upper surface and lower surface of the device 60B under test.

In some embodiments, the support unit 40B may be arranged such that the surface of the device 60B under test attached to the support unit 40B may be exposed through the optical window 430B of the substrate plate 400B.

Alternatively, in some embodiments, the support unit 40B may rotate about an axis in the first direction or the second direction. That is, the support unit 40B may be arranged such that the surface of the device 60B under test attached to the support unit 40B may be exposed through the optical window 430B of the substrate plate 400B.

Additionally, the device 60B under test can be provided with a high-temperature environment, enhancing the detection capability of the detected signal.

As such, the semiconductor device support plate 100B may also be used in existing devices. FIG. 18 illustrates the use of the semiconductor device support plate 100B in the OFI apparatus 1000B, but the present disclosure is not limited thereto. The semiconductor device support plate 100B may be used in any equipment requiring a high-temperature environment.

Although the embodiments of the present disclosure have been described with reference to the accompanying drawings, the present disclosure is not limited to these embodiments and may be manufactured in various other forms. Those skilled in the art will understand that the technical scope or essential characteristics of the present disclosure can be modified and implemented in other specific forms without departing from the scope of the invention. Therefore, the embodiments described above should be understood as being illustrative in all respects and not limiting.

What is claimed is:

1. An optical fault detection apparatus, comprising:
a plate including:
an opening located at a center of the plate and extending through a thickness of the plate;
a magnetic body disposed along an edge of the opening; and
a support unit configured to attach the device under test to the plate, the support unit including a first sub-support unit and a second sub-support unit, each of the first sub-support unit and the second sub-support unit extending in a first direction and being spaced apart from each other in a second direction perpendicular to the first direction, the first sub-support unit and the second sub-support unit being attachable to the magnetic body; and
an optical device configured to be positioned at one of a first location above the opening and a second location below the opening detect, the optical device being configured to detect a defect in a device under test,
wherein the device under test includes a first surface attachable to the support unit, and a second surface opposite the first surface, and the first surface is exposed to the optical device through the opening.

2. The optical fault detection apparatus of claim 1, wherein the plate is arranged relative to the optical device such that the first surface of the device under test faces the optical device.

3. The optical fault detection apparatus of claim 1, wherein the plate is arranged relative to the optical device such that the second surface of the device under test faces the optical device.

4. The optical fault detection apparatus of claim 1, further comprising:
a temperature control device configured to control a temperature of the support unit,
wherein:
the first sub-support unit includes a first heating element configured to supply heat to the device under test;
the second sub-support unit includes a second heating element configured to supply heat to the device under test; and
the temperature control device is configured to independently control temperatures of the first heating element and the second heating element.

5. The optical fault detection apparatus of claim 4, wherein:
the device under test includes:
a first edge area overlapping with the first sub-support unit;
a second edge area overlapping with the second sub-support unit; and
a test area disposed between the first edge area and the second edge area along the first direction, the test area including a first test area adjacent to the first support region and a second test area adjacent to the second support region, the second test area being disposed between the first test area and the second support region along the first direction, and
the temperatures of the first test area and the second test area are different.

6. The optical fault detection apparatus of claim 4, wherein the temperature control device includes a monitor configured to:
monitor the temperatures of the first sub-support unit and the second sub-support unit; and
monitor a temperature of the device under test.

7. The optical fault detection apparatus of claim 1, wherein the device under test includes a wafer or a semiconductor package.

8. The optical fault detection apparatus of claim 1, further comprising:
a probe configured to provide a test signal for defect detection to the device under test.

9. The optical fault detection apparatus of claim 1, wherein:
the device under test includes a semiconductor element layer between a first wiring layer and a second wiring layer; and
the first wiring layer supplies power to the semiconductor element layer.

10. A semiconductor device support plate, comprising:
a plate including:
an opening located at a center of the plate;
a magnetic body disposed along an outer edge of the opening;
a support unit configured to fix a semiconductor device to the plate, the support unit including a first sub-support unit and a second sub-support unit, each of the first sub-support unit and the second sub-support unit extending in a first direction and being spaced apart from each other in a second direction perpendicular to the first direction, the first sub-support unit and the second sub-support unit being attachable to the magnetic body; and
a temperature control device configured to control a temperature of the support unit,
wherein:
the semiconductor device includes a first surface in contact with the support unit and a second surface opposite the first surface, and
the first surface is exposed through the opening.

11. The semiconductor device support plate of claim 10, wherein:
the semiconductor device is tested by an optical device configured to detect a defect in the semiconductor device; and
the optical device detects the defect while facing the first surface.

12. The semiconductor device support plate of claim 10, wherein:
the semiconductor device is tested by an optical device configured to detect a defect in the semiconductor device; and
the optical device detects the defect while facing the second surface.

13. The semiconductor device support plate of claim 10, wherein:
the first sub-support unit includes a first heating element configured to supply heat to the semiconductor device;
the second sub-support unit includes a second heating element configured to supply heat to the semiconductor device; and
the temperature control device independently controls temperatures of the first heating element and the second heating element.

14. The semiconductor device support plate of claim 10, wherein:
the semiconductor device includes:
a first edge area overlapping with the first sub-support unit;
a second edge area overlapping with the second sub-support unit; and
a test area between the first support region and the second support region, the test area including a first test area adjacent to the first support region and a second test area adjacent to the second support region; and
temperatures of the first test area and the second test area are different.

15. The semiconductor device support plate of claim 10, wherein the temperature control device includes a monitor configured to:
monitor temperatures of the first sub-support unit and the second sub-support unit; and
monitor a temperature of the semiconductor device.

16. The semiconductor device support plate of claim 10, wherein the semiconductor device includes a wafer or a semiconductor package.

17. The semiconductor device support plate of claim 10, wherein:
the semiconductor device includes a semiconductor element layer between a first wiring layer and a second wiring layer; and
the first wiring layer supplies power to the semiconductor element layer.

18. An optical fault detection apparatus, comprising:
an optical device configured to detect a defect in a device under test;
a support unit configured to hold the device under test, the support unit including:
a first sub-support unit including a first heating element configured to supply heat to the device under test; and
a second sub-support unit including a second heating element configured to supply heat to the device under test, wherein the device under test attachable to the first sub-support unit and the second sub-support unit;
a substrate plate configured to be attached to the support unit, the substrate plate including an optical window configured to expose the device under test to the optical device;
a temperature control device configured to:
independently control the temperature of the first heating element and the second heating element; and
monitor the temperatures of the support unit and the device under test; and
a probe configured to transmit a test signal to the device under test for detecting a defect.

19. The optical fault detection apparatus of claim 18, wherein:
the device under test includes a first surface and a second surface opposite the first surface; and
the support unit is attached to the substrate plate such that the first surface faces the optical device.

20. The optical fault detection apparatus of claim 18, wherein:
the device under test includes a first surface and a second surface opposite the first surface; and
the support unit is attached to the substrate plate such that the second surface faces the optical device.
